(19) United States
(12) Patent Application Publication
(10) Pub. No.: US 2020/0281407 A1
(43) Pub. Date: Sep. 10, 2020

(54) EASILY CLEANABLE WATER AND OIL FRYER

(71) Applicant: SAMYANG EMC Co., Ltd., Siheung-si, (KR)

(72) Inventor: Seong Joong KIM, Siheung-si (KR)

(73) Assignee: SAMYANG EMC Co., Ltd., Siheung-si (KR)

(21) Appl. No.: 16/712,076

(22) Filed: Dec. 12, 2019

(30) Foreign Application Priority Data
Mar. 4, 2019 (KR) 10-2019-0024803

(51) Int. Cl. A47J 37/12

(52) U.S. Cl. CPC A47J 37/1285; A47J 37/1223; A47J 37/1266

(57) ABSTRACT

Provided is an easily cleanable water and oil fryer. A fryer body has an accommodation space for water and oil. Frying residue is collected the fryer body by a cyclone. The fryer body is seated within a base frame. A controller is disposed in the base frame. A heater heats the oil. A cleaning circulation line includes a drain pipe disposed in a lower central portion of the fryer body to receive the water and the frying residue are introduced, a connecting pipe connected to the drain pipe via a connector, and an inlet pipe connected to the drain pipe via the connecting pipe to circulate the water by resupplying the water, from which the frying residue is removed by a filter unit, in response to opening and closing of a bidirectional valve. A circulation pump is connected to the cleaning circulation line to circulate the water.

### CROSS REFERENCE TO RELATED APPLICATION

The present application claims priority to Korean Patent Application No. 10-2019-0024803, filed in the Republic of Korea on Mar. 4, 2019, which is hereby incorporated by reference for all purposes as if fully set forth herein.

### BACKGROUND

### Field

The present disclosure relates to a fryer and, more particularly, to a water and oil fryer for cooking fried food using a difference in the specific gravities between water and oil.

### Description

A fryer related to the present disclosure is disclosed in, for example, Korean Patent No. 10-1399095 (Patent Document 1). According to this document, a water and oil fryer refers to a fryer in which both water and oil are supplied to the fryer, but fried food is cooked using heated oil, on the basis of the separation of water and oil.

The water and oil fryer cooks fried foods using only oil floating above water, on the basis of a phenomenon in which oil floats while water sinks due to the difference in the specific gravities between water and oil. While fried foods are being cooked, frying flour or residue from the oil sinks down into the water.

Accordingly, oil can be maintained to be clean for an extended period of time, and the acidification of oil can also be restrained, thereby reducing the amount of oil consumed. In addition, since a proper amount of water can be maintained in oil, the flavor of fried foods can be improved.

A water circulator and a water outlet are provided in the lower portion of a body in the water and oil fryer in order to discharge water and frying residue. In this manner, the water and oil fryer is cleaned.

However, in the water and oil fryer of the related art, since the water circulator and the water outlet are provided separately while being operated in concert with each other, there may be a structural problem in that separate spaces accommodating the water circulator and the water outlet are necessary.

For example, the water and oil fryer of the related art should not only have a space accommodating the water circulator, but also have a space accommodating the water outlet. Accordingly, the water and oil fryer can only be accommodated in an area having a relatively large space, which is problematic.

The information disclosed in the Background section is only provided for a better understanding of the background and should not be taken as an acknowledgment or any form of suggestion that this information forms prior art that would already be known to a person having ordinary skill in the art.

### BRIEF SUMMARY

Various aspects of the present disclosure provide a water and oil fryer having an improved water circulation structure able to easily discharge frying residue that has accumulated in the bottom of the fryer during circulation and reuse of water.

According to an aspect, a water and oil fryer may include: a fryer body having defined therein an accommodation space in which water and oil are accommodated, the fryer body being configured such that frying residue is collected in a central portion of a bottom thereof by a cyclone; a base frame supporting the fryer body seated within an upper portion of the base frame; a controller disposed in the upper portion of the base frame; a heater disposed on the base frame to heat the oil, with a bottom end portion of the heater being received in the accommodation space; a cleaning circulation line including a drain pipe disposed in a lower central portion of the fryer body, such that the water and the frying residue are introduced to the drain pipe, a connecting pipe connected to the drain pipe via a connector, and an inlet pipe connected to the drain pipe via the connecting pipe to circulate the water by resupplying the water, from which the frying residue is removed by a filter unit, in response to opening and closing of a bidirectional valve; and a circulation pump connected to the cleaning circulation line to circulate the water, whereby the water and oil fryer is easily cleanable.

In addition, in the water and oil fryer according to an embodiment of the disclosure, the cleaning circulation line may be configured such that one end portion of the drain pipe is connected to the drain hole provided in the lower central portion of the fryer body, the other end portion of the drain pipe is connected to a first passage of the connector disposed on the upper portion of the base frame, a top end portion of the connecting pipe is connected to a second passage of the connector communicating with the first passage, the filter unit is disposed on a bottom end portion of the connecting pipe, one end portion of the inlet pipe is connected to the filter unit, and the other end portion of the inlet pipe is connected to the lower portion of the fryer body.

In addition, in the water and oil fryer according to an embodiment of the disclosure, the controller may cause the bidirectional valve and the circulation pump to work in concert with each other.

In addition, in the water and oil fryer according to an embodiment of the disclosure, the filter unit may be disposed in a location at which the connecting pipe and the inlet pipe are connected to remove the frying residue using a filter disposed inside thereof, the filter being detachably disposed inside of the filter unit.

In addition, the easily cleanable water and oil fryer according to an embodiment of the disclosure may further include a check valve disposed on a sewer pipe connected to the filter unit to be opened and closed by the controller. When the check valve and the bidirectional valve are opened by the controller, water may be discharged from the fryer body to a sewer line through the inlet pipe.

Furthermore, in the water and oil fryer according to an embodiment of the disclosure, the heater may include: a heating coil, with a bottom end portion of the heating coil being accommodated in the accommodation space, and a top end portion of the heating coil being connected to the controller; and a cover disposed on the upper portion of the base frame to hide the heating coil from the outside, the cover being able to turn.

The above and other objects, features, and advantages of the present disclosure will be more clearly understood from the following detailed description when taken in conjunction with the accompanying drawings.

In the meantime, terms and words used in the specification and the appended claims should not be interpreted as having ordinary or dictionary meanings, but as meanings and concepts conforming to the technical spirit of the present disclosure based on the principle that an inventor may properly define the concept of the terms at his/her own discretion in order to describe the invention in the best manner possible.

According to an embodiment of the present disclosure, the improved water circulation structure can easily discharge frying residue that has accumulated in the bottom of the fryer during circulation and reuse of water. Accordingly, the water and oil fryer can be conveniently cleaned and thus can be hygienically managed to be clean, thereby effectively improving the reliability thereof.

### DESCRIPTION OF DRAWINGS

FIG. 1 is a side view schematically illustrating a configuration of an easily cleanable water and oil fryer according to an embodiment of the disclosure;

FIG. 2 is a top view schematically illustrating the configuration of the easily cleanable water and oil fryer according to the embodiment of the disclosure; and

FIG. 3 is a perspective view schematically illustrating the configuration of the easily cleanable water and oil fryer according to the embodiment of the disclosure.

### DETAILED DESCRIPTION

Hereinafter, reference will now be made to embodiments of the present disclosure in detail, examples of which are illustrated in the accompanying drawings. Reference should be made to the drawings, in which the same reference numerals and symbols may be used to designate the same or like components. In the following description of the present disclosure, detailed descriptions of known functions and components incorporated herein will be omitted in the case that the subject matter of the present disclosure may be rendered unclear thereby.

It will be understood that, while terms, such as “first,” “second,” “A,” “B,” “(a),” and “(b),” may be used herein to describe various elements, such terms are merely used to distinguish one element from another element. The substance, sequence, or order of such elements are not limited by these terms. It will be understood that when an element is referred to as being “connected to”, “coupled to”, or “in contact with” another element, not only can it be “directly connected to”, “directly coupled to”, or “in direct contact with” the other element, but it also can be “indirectly connected to”, “indirectly coupled to”, or “indirectly in contact with” the other element via an “intervening” element.

Hereinafter, embodiments of the disclosure will be described in detail with reference to the accompanying drawings.

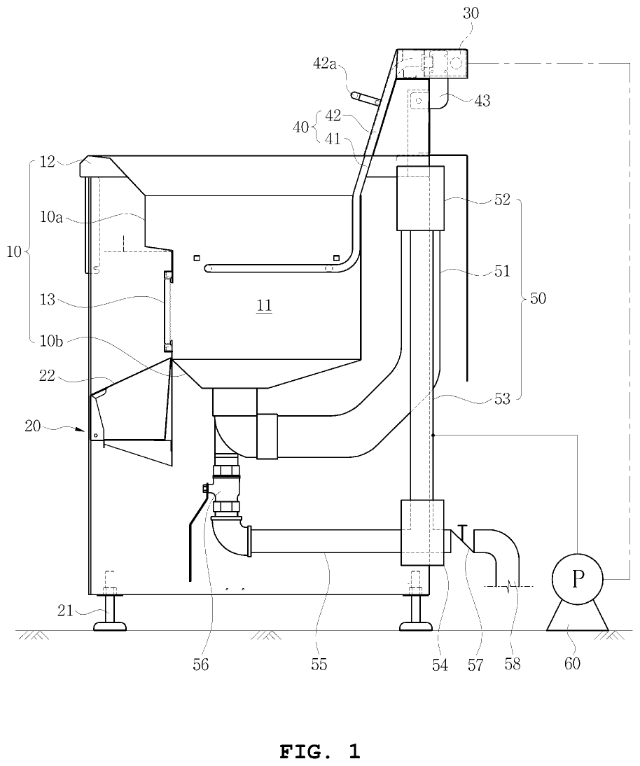

FIG. 1 is a side view schematically illustrating a configuration of an easily cleanable water and oil fryer according to an embodiment of the disclosure. In FIG. 1, a connecting relationship of a cleaning circulation line 50 is illustrated. In the cleaning circulation line 50, a drain pipe 51 is disposed in the lower central portion of a fryer body 10 seated within the upper portion of a base frame 20, on the upper portion of which a controller 30 is disposed, and an inlet pipe 55 is connected to the drain pipe 51 via a connector 52 and a connecting pipe 53.

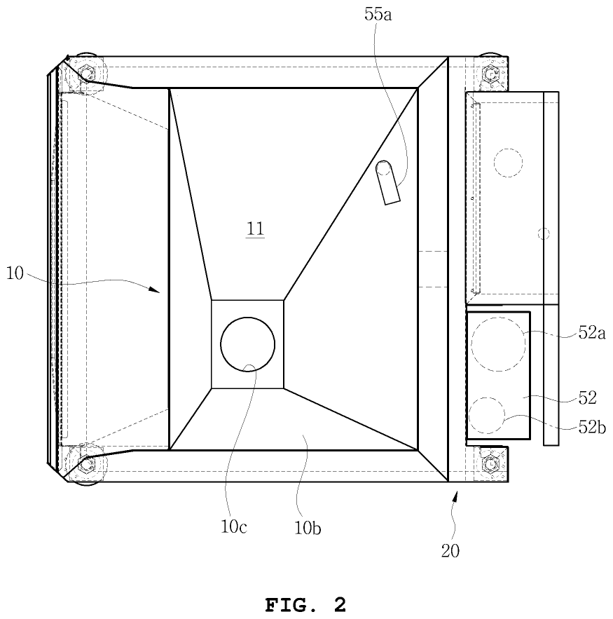

FIG. 2 is a top view schematically illustrating the configuration of the easily cleanable water and oil fryer according to the embodiment of the disclosure. Referring to a connection relationship illustrated in FIG. 2, an inlet nozzle 55a is disposed in an accommodation space 11 of the fryer body 10, and the connector 52 is disposed outside of the base frame 20.

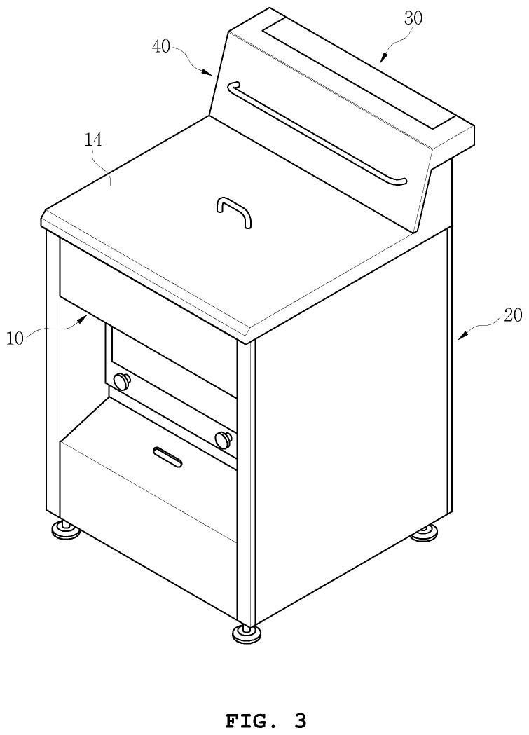

FIG. 3 is a perspective view schematically illustrating the configuration of the easily cleanable water and oil fryer according to the embodiment of the disclosure. Referring to a connection relationship of FIG. 3, the fryer body 10, a heater 40, and the controller 30 are disposed on the base frame 20. An upper cover 14 is provided to open and close the upper portion of the fryer body 10.

As illustrated in FIGS. 1 to 3, the easily cleanable water and oil fryer according to the embodiment of the disclosure is a cooking device for making fried foods using a phenomenon in which water and oil are separated due to different specific gravities thereof. In the water and oil fryer, the fryer body 10 is seated within the upper portion of the base frame 20, and has defined therein the accommodation space 11 in which water and oil are accommodated. The fryer body 10 is configured such that frying residue is collected in the central portion of the bottom thereof by a cyclone. The heater 40 is disposed on the base frame 20 to heat oil, with the bottom end portion of the heater 40 being received in the accommodation space 11.

The fryer body 10 is comprised of an upper body portion 10a and a lower conical portion 10b sharing the accommodation space 11 defined within the fryer body 10. A flange 12 is provided on the upper portion of the upper body portion 10a, such that the upper body portion 10a is seated on the upper inner portion of the base frame 20 via the flange 12. A drain hole 10c is provided in the central portion of the bottom of the lower conical portion 10b.

An indicator 13 may be provided on a front portion of the fryer body 10, corresponding to the left side of the drawing. The indicator 13 allows the state of water contained in the accommodation space 11 to be viewed externally.

In addition, the fryer body 10 may be provided with a water level sensor or the like disposed in the accommodation space 11 to detect a water level, such that the fryer body 10 can be operated in concert with the controller 30. The accommodation space 11 may be opened and closed by the upper cover 14.

The fryer body 10 is seated on top of the base frame 20. The top end portions of the controller 30 and the heater 40 may be disposed on the upper portion of the base frame 20. Height adjustment devices 21, such as height adjustment bolts, may be rotatably disposed on the lower portion of the base frame 20. In addition, a control panel 22 able to operate the controller 30 may be disposed in a front portion of the base frame 20, corresponding to the left side in FIG. 1.

The controller 30 is provided to control a period of time in which oil is heated using the heater 40, as well as the operation of the cleaning circulation line 50 and a circulation pump 60 for circulating water. The controller 30 is directly or indirectly connected to the cleaning circulation line 50 and the circulation pump 60, and is disposed on the upper portion of the base frame 20.

That is, a configuration in which a heating coil 41 of the heater 40 is directly connected to the controller 30 is illustrated, and a configuration in which the circulation pump 60 and the controller 30 are indirectly connected is illustrated.

The heater 40 is disposed in the base frame 20 such that the bottom end portion of the heater 40 is accommodated in the accommodation space 11 and the top end portion of the heater 40 is connected to the controller 30. The heater 40 heats oil to a temperature ranging from 160° C. to 180° C., under the control of the controller 30.

For example, the heater 40 may be implemented as the heating coil 41, with the bottom end being accommodated in the accommodation space 11 and the top end being connected to the controller 30. Here, the heater 40 may further include a cover 42 disposed on the upper portion of the base frame 20 to hide the heating coil 41 from the outside. The cover 42 may be configured to turn.

The cover 42 may hide the front and side portions of the heating coil 41 so as not to be exposed externally, thereby preventing an accident during a fried food making process. In addition, the cover 42 may be disposed on the upper portion of the base frame 20 by means of an L-shaped bracket 43, thereby facilitating the maintenance of the heating coil 41.

In addition, the cover 42 may have a handle 42a provided on the front portion thereof. The handle 42a facilitates the operation of turning the cover 42 forwardly.

Accordingly, the water and oil fryer according to an embodiment makes it possible to easily and safely produce fried foods, thereby improving the reliability thereof.

In addition, the easily cleanable water and oil fryer according to an embodiment of the disclosure further includes a cleaning circulation line 50 for removing and cleaning frying residue occurring in the process of cooking fried foods by circulating water in the interior of the fryer body 10 and a circulation pump 60 disposed on the cleaning circulation line 50 to circulate water.

The cleaning circulation line 50 includes: the drain pipe 51 disposed in the lower central portion of the fryer body 10 to communicate with the drain hole 10c provided in the lower conical portion 10b of the fryer body 10; the connecting pipe 53 connected to the drain pipe 51 via the connector 52; and the inlet pipe 55 connected to the drain pipe 51 via the connecting pipe 53 to circulate water by resupplying water, from which frying residue is removed by a filter unit 54, in response to the opening and closing of a bidirectional valve 56.

Due to this configuration, when the circulation pump 60 is driven, water and frying residue introduced to the drain pipe 51 are supplied to the filter unit 54 via the connector 52 and the connecting pipe 53, are filtered by the filter unit 54, and are then resupplied to the fryer body 10. Accordingly, a cleaning operation is performed by circulating water.

Here, the bidirectional valve 56 disposed on the inlet pipe 55 may be opened and closed manually, or may be opened and closed automatically under the control of the controller 30. The bidirectional valve 56 may work in concert with the circulation pump 60, under the control of the controller 30.

The drain pipe 51 is, for example, U-shaped, with one end of the drain pipe 51 being connected to the lower central portion of the fryer body 10, and the other end of the drain pipe 51 being connected to the connector 52 disposed on the upper portion of the base frame 20. The connector 52 has a first passage 52a and a second passage 52b provided therein. The first passage 52a is connected to the drain pipe 51, and the second passage 52b is connected to the connecting pipe 53, such that the drain pipe 51 and the connecting pipe 53 are connected.

The connecting pipe 53 is a straight pipe, with the top end portion thereof being connected to the second passage 52b of the connector 52, and the bottom end portion thereof being connected to the filter unit 54. In addition, one end portion of the inlet pipe 55 is connected to the filter unit 54, and the other end portion of the inlet pipe 55 is connected to an inclined surface of the lower conical portion 10b of the fryer body 10.

Here, the filter unit 54 is disposed in a location at which the connecting pipe 53 and the inlet pipe 55 are connected, and removes frying residue using a filter (not shown) disposed therein. The filter may be detachably disposed inside of the filter unit 54, such that the filter is easily replaceable with a new filter when the lifetime of the filter is completed.

In addition, the inlet nozzle 55a may be disposed on the inner side of the inclined surface of the lower conical portion 10b, to which the other end portion of the inlet pipe 55 is connected, such that water, from which frying residue is removed, can be easily resupplied.

The circulation pump 60 is connected to one of the drain pipe 51, the connecting pipe 53, and the inlet pipe 55 of the cleaning circulation line 50 to pump and recirculate water. In FIG. 1, the circulation pump 60 is illustrated as being connected to the connecting pipe 53, as an example.

According to an embodiment, when the circulation pump 60 operates under the control of the controller 30 and the bidirectional valve 56 is opened, frying residue and water, collected in the central portion of the bottom of the fryer body 10, are drained through the drain pipe 51 and are then supplied to the filter unit 54 through the connector 52 and the connecting pipe 53, so that the frying residue is filtered by the filter unit 54, and only water is resupplied to the fryer body 10, thereby preventing the frying residue from accumulating in the bottom of the fryer body 10.

The cleaning circulation line 50 according to an embodiment may further include a check valve disposed between the inlet pipe 55 and a sewer line to discharge water to the sewer line after the water has been circulated for a predetermined period of time. The opening and closing of the check valve 57 may also be controlled by the controller 30.

Here, the check valve 57 is connected to the inlet pipe 55 via a sewer pipe 58 connected to the filter unit 54, and allows only water, from which frying residue is removed, to be discharged to the sewer line, thereby preventing the contamination of the sewer line.

That is, when the check valve 57 and the bidirectional valve 56 are opened by the controller 30, drain water is supplied to the filter unit 54 through the inlet pipe 55 serving as a discharge pipe, so that frying residue is completely removed by the filter unit 54. Consequently, filtered water is discharged to the sewer line through the sewer pipe 58.

As set forth above, according to the present disclosure, it is possible to provide the easily cleanable water and oil fryer, in which the fryer body 10 can be cleaned by completely draining water from the fryer body 10, so that the fryer body can be easily cleaned and the sewage treatment regulations can be satisfied, thereby improving the reliability of the water and oil fryer.

Although the foregoing embodiments of the present disclosure have been described in detail, this is for illustrative purposes only. The easily cleanable water and oil fryer according to the present disclosure is not limited thereto. In addition, it will be understood that the terms “comprise”, “include”, and “have”, used herein specify the presence of stated elements but do not preclude the presence or addition of any other elements unless explicitly noted. Unless otherwise defined, all terms including technical and scientific terms used herein have the same meaning as commonly understood by a person having ordinary knowledge in the art to which the present disclosure pertains.

The foregoing descriptions and the accompanying drawings have been presented in order to explain certain principles of the present disclosure. A person having ordinary knowledge in the art to which the present disclosure pertains could make a variety of modifications and variations by combining, dividing, substituting for or changing elements without departing from the principle of the present disclosure. The foregoing embodiments disclosed herein shall be interpreted as being illustrative only, while not being limitative, of the principle and scope of the present disclosure. It should be understood that the scope of the present disclosure shall be defined by the appended Claims and all of their equivalents fall within the scope of the present disclosure.

What is claimed is:

1. A water and oil fryer comprising:
a fryer body having defined therein an accommodation space in which water and oil are accommodated, the fryer body being configured such that frying residue is collected in a central portion of a bottom thereof by a cyclone;
a base frame supporting the fryer body seated within an upper portion of the base frame;
a controller disposed in the upper portion of the base frame;
a heater disposed on the base frame to heat the oil, with a bottom end portion of the heater being received in the accommodation space;
a cleaning circulation line including a drain pipe disposed in a lower central portion of the fryer body, such that the water and the frying residue are introduced to the drain pipe, a connecting pipe connected to the drain pipe via a connector, and an inlet pipe connected to the drain pipe via the connecting pipe to circulate the water by resupplying the water, from which the frying residue is removed by a filter unit, in response to opening and closing of a bidirectional valve; and
a circulation pump connected to the cleaning circulation line to circulate the water,
whereby the water and oil fryer is easily cleanable.

2. The water and oil fryer according to claim 1, wherein the cleaning circulation line is configured such that one end portion of the drain pipe is connected to the drain hole provided in the lower central portion of the fryer body, the other end portion of the drain pipe is connected to a first passage of the connector disposed on the upper portion of the base frame, a top end portion of the connecting pipe is connected to a second passage of the connector communicating with the first passage, the filter unit is disposed on a bottom end portion of the connecting pipe, one end portion of the inlet pipe is connected to the filter unit, and the other end portion of the inlet pipe is connected to the lower portion of the fryer body.

3. The water and oil fryer according to claim 1, wherein the controller causes the bidirectional valve and the circulation pump to work in concert with each other.

4. The water and oil fryer according to claim 1, wherein the filter unit is disposed in a location at which the connecting pipe and the inlet pipe are connected to remove the frying residue using a filter disposed inside thereof, the filter being detachably disposed inside of the filter unit.

5. The water and oil fryer according to claim 2, wherein the filter unit is disposed in a location at which the connecting pipe and the inlet pipe are connected to remove the frying residue using a filter disposed inside thereof, the filter being detachably disposed inside of the filter unit.

6. The water and oil fryer according to claim 1, further comprising a check valve disposed on a sewer pipe connected to the filter unit to be opened and closed by the controller,
wherein, when the check valve and the bidirectional valve are opened by the controller, water is discharged from the fryer body to a sewer line through the inlet pipe.
